(19) United States
(12) Patent Application Publication
(10) Pub. No.: US 2026/0112811 A1
(43) Pub. Date: Apr. 23, 2026

(54) RECONFIGURABLE TUNABLE BROADBAND ANTENNA COMPONENTS

(71) Applicant: Western Digital Technologies, Inc., San Jose, CA (US)

(72) Inventor: Daniel BEDAU, San Jose, CA (US)

(73) Assignee: Western Digital Technologies, Inc., San Jose, CA (US)

(21) Appl. No.: 18/920,861

(22) Filed: Oct. 19, 2024

(51) Int. Cl. H01Q 3/24; H01Q 5/328

(52) U.S. Cl. CPC H01Q 3/24; H01Q 5/328

(57) ABSTRACT

An antenna component may include a first circuit comprising a first selector coupled in series to a first memory cell, a second circuit comprising a second selector coupled in series to a second memory cell, a first antenna element coupled to the first circuit, a second antenna element coupled to the second circuit, and control circuitry coupled to the first circuit and the second circuit, wherein the control circuitry is configured to use the first circuit to select the first antenna element and use the second circuit to select the second antenna element.

### BACKGROUND

Modern radio systems (e.g., for television and radio broadcasting, mobile networks (e.g., 4G, 5G, etc.), satellite communications, Wi-Fi and wireless networks, military and defense applications, the Internet of things (IoT), etc.) often have high bandwidths and are frequency-agile to avoid congestion, mitigate jamming, and/or match signals to channel propagation characteristics. The antennas used for such systems are designed to transmit and receive radio waves effectively, covering different frequency ranges and applications.

Modern antennas are designed to operate across a wide range of frequencies, from very low frequency (VLF) bands used in submarine communication to millimeter waves used in advanced radar and 5G technology. Antennas can be omnidirectional (receiving signals from all directions) or directional (focusing on a specific direction), depending on the application.

Gain refers to the ability of the antenna to direct or concentrate radio frequency energy in a particular direction, enhancing signal strength and reception quality. The bandwidth of an antenna is the range of frequencies over which the antenna can effectively operate. Wideband antennas can handle multiple frequencies simultaneously, which can be crucial for modern communication systems.

The radiation Q factor of an antenna is a measure of the bandwidth of the antenna relative to its size. A lower Q factor indicates a wider bandwidth, while a higher Q factor indicates a narrower bandwidth.

The well-known Chu-Harrington limit defines the trade-off between the size of an antenna and its bandwidth and efficiency. The Chu-Harrington limit is a theoretical limit that imposes constraints on how small an antenna can be made while still maintaining acceptable performance characteristics.

With advancements in materials and technology, antennas have become more compact and integrated into devices, which can compromise performance. The Chu-Harrington limit is particularly relevant for electrically small antennas, which are antennas whose physical dimensions are much smaller than the wavelength of the operating frequency. As antennas become smaller, their bandwidth tends to decrease and their efficiency can drop. Specifically, as the size of an antenna decreases, the Q factor increases, meaning that the antenna becomes more narrowband. Thus, there is a fundamental limit on how much an antenna's size can be reduced without sacrificing bandwidth.

Designers typically balance the desire for small antenna size with the need for sufficient bandwidth and efficiency. The design process often involves trade-offs, where improving one aspect can degrade another.

Accordingly, there is a need for improvements.

### SUMMARY

This summary represents non-limiting embodiments of the disclosure.

In some aspects, the techniques described herein relate to an antenna component, including: a first circuit including a first selector coupled in series to a first memory cell; a second circuit including a second selector coupled in series to a second memory cell; a first antenna element coupled to the first circuit; a second antenna element coupled to the second circuit; and control circuitry coupled to the first circuit and the second circuit, wherein the control circuitry is configured to use the first circuit to select the first antenna element and use the first circuit to select the second antenna element.

In some aspects, at least one of the first memory cell or the second memory cell is nonvolatile.

In some aspects, the antenna component further includes: a first wire coupled to a first terminal of the first circuit, to a first terminal of the second circuit, and to the control circuitry; a second wire coupled to a second terminal of the first circuit and to the control circuitry; and a third wire coupled to a second terminal of the second circuit and to the control circuitry, and wherein the control circuitry is configured to access the first circuit using the first wire and the second wire, and to access the second circuit using the first wire and the third wire.

In some aspects, the antenna component further includes: a reference plane; and a capacitor coupling at least one of the first wire, the second wire, the third wire, the first circuit, or the second circuit to the reference plane.

In some aspects, the antenna component further includes: a reference plane; and a capacitor coupling at least one the first circuit or the second circuit to the reference plane.

In some aspects, the first antenna element is connected to the first memory cell of the first circuit and the second antenna element is connected to the second memory cell of the second circuit.

In some aspects, the techniques described herein relate to an antenna component, including: a switching fabric including: a plurality of wires, and a plurality of selector-switch circuits, each of the plurality of selector-switch circuits being addressable by a respective unique pair of wires of the plurality of wires; and a plurality of antenna elements, wherein each antenna element of the plurality of antenna elements is coupled to the switching fabric to substantially prevent direct current on any of the plurality of wires from flowing through the plurality of antenna elements and to substantially prevent radio-frequency signals fed to or flowing through any of the plurality of antenna elements from flowing through the plurality of wires.

In some aspects, each selector-switch circuit of the plurality of selector-switch circuits includes a respective selector coupled in series to a respective memory cell. In some aspects, the respective memory cell is nonvolatile.

In some aspects, each selector-switch circuit of the plurality of selector-switch circuits includes: a respective first outer terminal coupled to a first wire of the respective unique pair of two wires; and a respective second outer terminal coupled to a second wire of the respective unique pair of two wires.

In some aspects, each selector-switch circuit of the plurality of selector-switch circuits further includes: a respective inner terminal coupled to a respective antenna element of the plurality of antenna elements.

In some aspects, each selector-switch circuit of the plurality of selector-switch circuits includes a respective memory cell, and the respective inner terminal couples the respective antenna element to the respective memory cell.

In some aspects, the antenna component further includes a phase shifter coupled to the plurality of antenna elements.

In some aspects, the plurality of antenna elements is arranged in a non-planar configuration.

In some aspects, the antenna component further includes one or more hardware elements coupled to the switching fabric and/or the plurality of antenna elements, wherein the one or more hardware elements are configured to substantially prevent the direct current on any of the plurality of wires from flowing through the plurality of antenna elements and/or to substantially prevent the radio-frequency signals fed to or flowing through any of the plurality of antenna elements from flowing through the plurality of wires. In some aspects, the one or more hardware elements include at least one of: a capacitor, an inductor, a split-ring resonator, a low-pass filter, a high-pass filter, a band-pass filter, a hybrid, a directional coupler, a band-stop filter, a notch filter, a splitter, a transformer, a waveguide filter, a stub, or a resistor.

In some aspects, the antenna component further includes: control circuitry coupled to the switching fabric and configured to use the plurality of wires to configure the plurality of selector-switch circuits to configure the plurality of antenna elements.

In some aspects, the techniques described herein relate to a method of using an antenna component, the method including: the control circuitry configuring the antenna component using the plurality of wires to configure the plurality of selector-switch circuits.

In some aspects, the method further includes: before the control circuitry configuring the antenna component using the plurality of wires to configure the plurality of selector-switch circuits, performing a calculation to determine a configuration of the plurality of selector-switch circuits.

In some aspects, the method further includes: before the control circuitry configuring the antenna component using the plurality of wires to configure the plurality of selector-switch circuits, retrieving a configuration of the plurality of selector-switch circuits from a database.

In some aspects, the method further includes: adjusting a configuration of the antenna component. In some aspects, adjusting the configuration of the antenna component is based at least in part on a signal strength, a radiated power, a suppression of interference, or a suppression of jamming.

In some aspects, the techniques described herein relate to an antenna component, including: a switching fabric including: a plurality of wires, and a plurality of selector-switch circuits, each of the plurality of selector-switch circuits being addressable by a respective unique pair of two wires of the plurality of wires; and a plurality of antenna elements coupled to the switching fabric; and at least one hardware element coupled to the plurality of selector-switch circuits and configured to (a) suppress a direct current path through the plurality of antenna elements, (b) substantially prevent radio-frequency signals fed to or flowing through any of the plurality of antenna elements from flowing through the plurality of wires, or (c) both (a) and (b).

In some aspects, the at least one hardware element includes at least one of: a capacitor, a split-ring resonator, an inductor, a low-pass filter, a high-pass filter, a band-pass filter, a hybrid, a directional coupler, a band-stop filter, a notch filter, a splitter, a transformer, a waveguide filter, a stub, or a resistor.

In some aspects, the plurality of wires and the plurality of selector-switch circuits are situated in a cross-point architecture structure.

### BRIEF DESCRIPTION OF THE DRAWINGS

Objects, features, and advantages of the disclosure will be readily apparent from the following description of certain embodiments taken in conjunction with the accompanying drawings in which:

FIG. 1A is a diagram of an antenna component in accordance with some embodiments.

FIG. 1B is a diagram of another antenna component in accordance with some embodiments.

FIG. 1C is a diagram of another antenna component in accordance with some embodiments.

FIG. 1D is a diagram illustrating an antenna component in accordance with some embodiments.

FIG. 1E is a diagram illustrating another antenna component in accordance with some embodiments.

FIG. 2A is a diagram illustrating an example of a switching fabric in accordance with some embodiments.

FIG. 2B is another illustration of a switching fabric in accordance with some embodiments.

FIG. 3A is an illustration of an antenna component in accordance with some embodiments.

FIG. 3B is an example to illustrate how the selector-switch circuits can be configured to connect antenna elements to each other in accordance with some embodiments.

FIG. 4A shows an alternative approach to couple the antenna elements together in accordance with some embodiments.

FIG. 4B illustrates one example solution to the problem of FIG. 4A in accordance with some embodiments.

FIG. 5 is an illustration of an example of an antenna component that allows additional combinations of antenna elements to be coupled together in accordance with some embodiments.

FIG. 6 is a diagram illustrating components of another antenna component in accordance with some embodiments.

FIG. 7 is a flow diagram of an example of a method of using an antenna component in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

Some of the drawings herein illustrate multiple instances of a feature, where each feature is designated by a common reference numeral followed by a different letter (e.g., antenna element 140A, antenna element 140B, selector-switch circuit 110A, selector-switch circuit 110B, capacitor 160A, capacitor 160B, capacitor 160C, etc.). For convenience, the detailed description sometimes refers to these features singularly or collectively using only the common reference numeral.

### DETAILED DESCRIPTION

Disclosed herein are techniques for providing reconfigurable and tunable broadband antennas. In some embodiments, an antenna component comprises switches, selectors, and wires situated in a switching fabric. The switching fabric is coupled to a plurality of antenna elements (e.g., radiators) such that radio-frequency (RF) signals fed to or flowing through the antenna elements do not interfere with addressing/selection/configuration signals transmitted on the wires of the switching fabric, and vice versa. The switching fabric is a hardware architecture to manage the antenna elements. Using the switching fabric, individual antenna elements can be selected, addressed, and configured. The switching fabric can take any suitable form (e.g., a cross-point architecture structure or a bus-based fabric using a shared bus). In some embodiments, the isolation is effected by capacitively coupling the antenna elements to the switching fabric and/or by inductively loading the wires of the switching fabric.

In some embodiments, the switches and/or selectors include phase change materials (PCM), Ovonic threshold switching (OTS) materials, and/or resistive random access memory (ReRAM) cells in a switching fabric to allow individual or multiple antenna elements (e.g., radiators, elements of a metasurface, etc.) to be configured and/or reconfigured rapidly and to allow the frequency response and/or directionality of an overall antenna to be configured or adjusted. The antenna elements can be in a planar orientation (e.g., situated in a two-dimensional plane), or they can be distributed in a non-planar, three-dimensional configuration (e.g., they can be situated on a sphere, toroid, in a cube, etc.).

As used herein, the term “switch” refers to hardware recognized by those having ordinary skill in the art as providing switching functionality. A switch can be a single, stand-alone component, or it can be a device or circuit that includes additional circuitry, such as one or more wires, one or more power sources, one or more transistors, one or more diodes, one or more resistors, one or more capacitors, one or more relays, one or more PIN diodes, one or more inductors, and/or other hardware. For example, switches can include latching circuits, which can comprise, for example, static random access memory (SRAM) cells. As another example, switches can include a dynamic random access memory (DRAM) circuit.

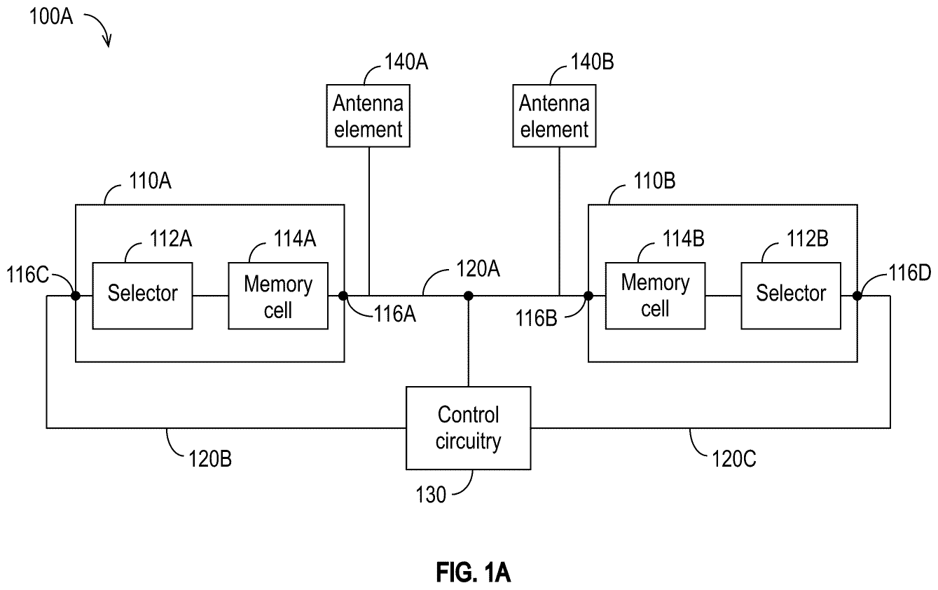

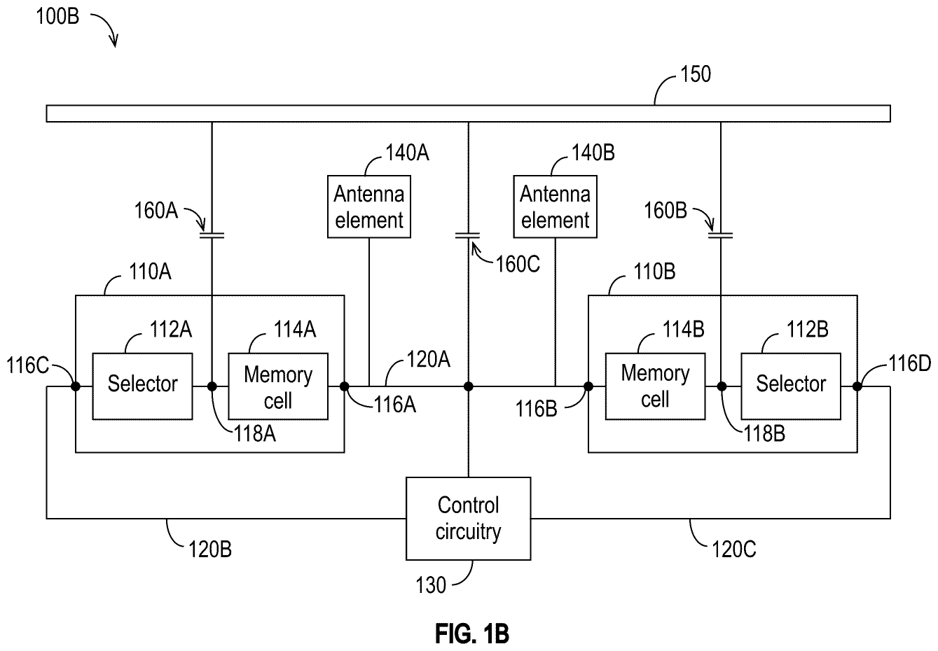

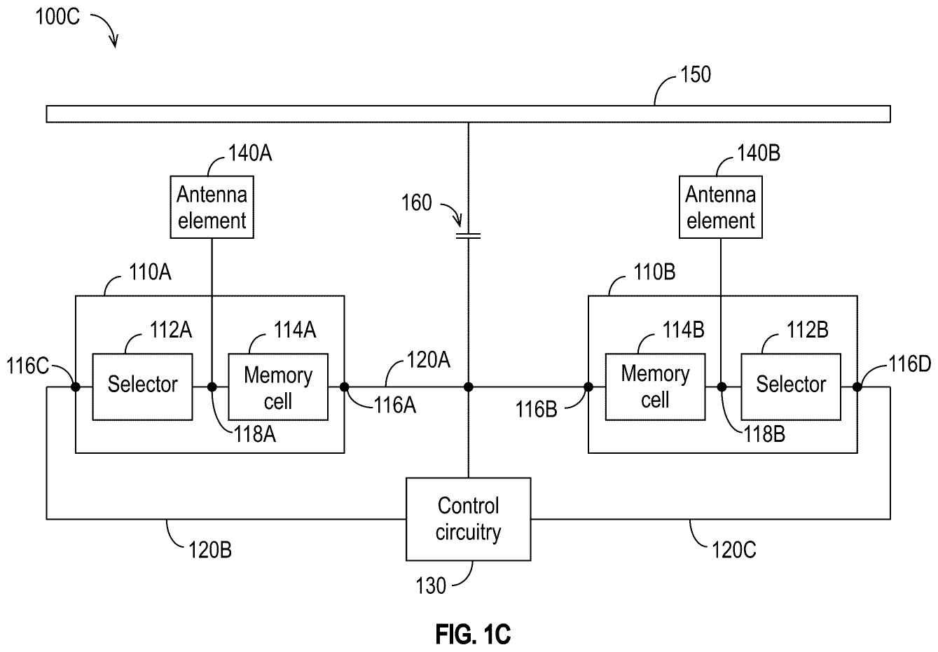

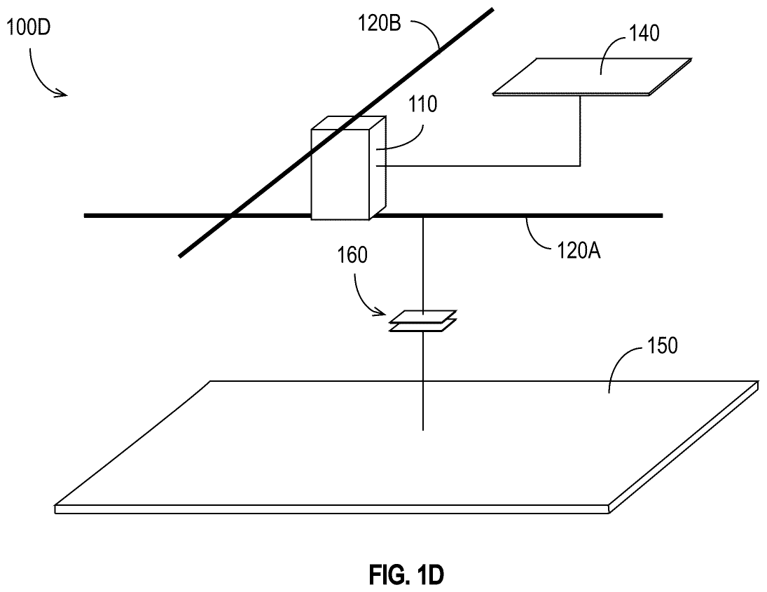

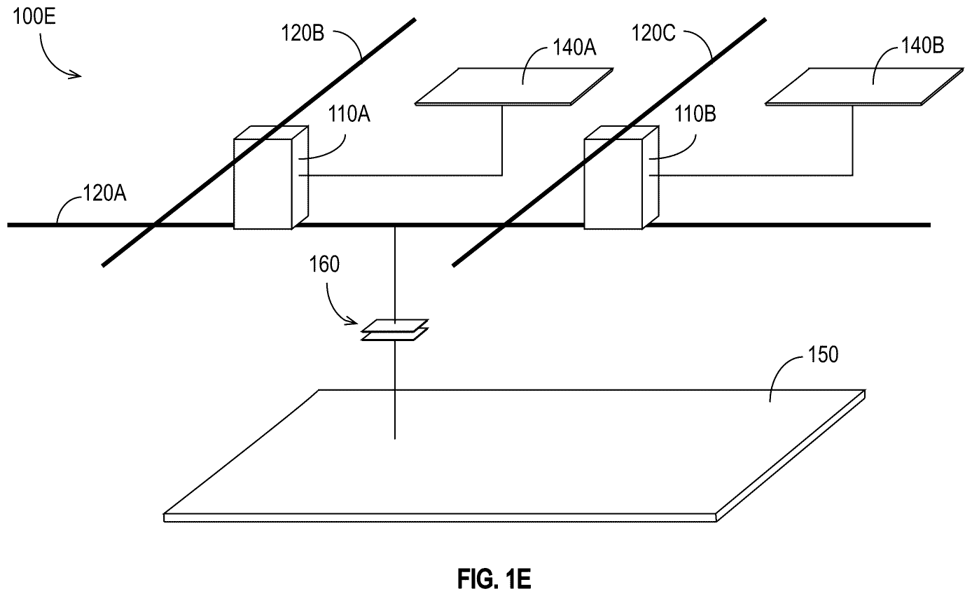

FIG. 1A is a diagram of an antenna component 100A in accordance with some embodiments. The antenna component 100A can be, for example, part of an overall antenna. The antenna component 100A includes an antenna element 140A and an antenna element 140B. The antenna element 140A and/or antenna element 140B can be any component or components that transmit, receive, or control waves or signals transmitted or received by the overall antenna into which the antenna component 100A is incorporated. For example, the antenna element 140A and/or antenna element 140B can be elements of a metasurface. As will be appreciated by those having ordinary skill in the art, a metasurface is a two-dimensional metamaterial designed to control various aspects of wave propagation, such as phase, amplitude, polarization, and direction. Metasurface elements are typically much smaller than the wavelength of the electromagnetic waves they interact with (e.g., on the order of one-tenth to one-hundredth of the wavelength). Metasurface elements can comprise resonant structures, such as one or more of split-ring resonators, plasmonic nanoparticles, or dielectric resonators. Examples of metasurface elements include, but are not limited to, reflectarray elements (e.g., elements that act like small, flat mirrors with adjustable phase responses, enabling beamforming in reflectarray antennas), transmitarray elements (e.g., elements designed to transmit rather than reflect the incoming waves, focusing or steering the transmitted beam), and Huygens metasurfaces (e.g., elements that simultaneously control both the electric and magnetic responses).

As another example, the antenna element 140A and/or the antenna element 140B can be radiators. As will be appreciated, an antenna radiator emits and/or receives electromagnetic waves. When transmitting, the radiator converts electrical energy into electromagnetic waves (e.g., radio-frequency (RF) signals). When receiving, incoming electromagnetic waves induce current in the radiator, which converts them back into electrical signals. The antenna element 140A and antenna element 140B can be any suitable radiators, such as, for example, dipole radiators (two straight conductive elements), loop radiators, or patch radiators. As will be appreciated, the antenna element 140A and antenna element 140B have or are connected to ports (e.g., RF ports) that provide signals to and/or convey signals from the antenna element 140A and antenna element 140B. To avoid obscuring the drawing, the feeds for the antenna element 140A and antenna element 140B are not illustrated in FIG. 1A, or in other drawings herein.

As another example, the antenna element 140A and/or the antenna element 140B can form passive or parasitic radiators that are not connected to any RF ports. As will be appreciated, a parasitic radiator couples electromagnetically to the driven element and serves to modify the radiation pattern of the driven element. The parasitic elements can have any suitable shape (e.g., a dipole). In some embodiments that include parasitic radiators, the parasitic radiators act as directors by narrowing the radiation patterns. In some embodiments that include parasitic radiators, the parasitic radiators act as reflectors by directing the radiation toward one side of the antenna. In some embodiments that include parasitic radiators, both reflectors and directors are used simultaneously.

The antenna component 100A also includes a selector-switch circuit 110A and a selector-switch circuit 110B. The selector-switch circuit 110A has an outer terminal 116A and an outer terminal 116C, and the selector-switch circuit 110B has an outer terminal 116B and an outer terminal 116D. The outer terminal 116B of the selector-switch circuit 110B is coupled to the outer terminal 116A of the selector-switch circuit 110A by a wire 120A.

The antenna element 140A and the antenna element 140B are also coupled to the wire 120A. Therefore, the antenna element 140A is coupled to the selector-switch circuit 110A, and the antenna element 140B is coupled to the selector-switch circuit 110B.

The antenna component 100A also includes control circuitry 130. The control circuitry 130 may comprise, for example, a voltage source, a current source, and/or any other component that allows the control circuitry 130 to control the selector-switch circuit 110A and selector-switch circuit 110B. In the illustrated example, the control circuitry 130 is coupled to the wire 120A, to the outer terminal 116C of the selector-switch circuit 110A by a wire 120B, and to the outer terminal 116D of the selector-switch circuit 110B by a wire 120C. The control circuitry 130 is configured to use the wire 120A and the wire 120B to select the antenna element 140A, and to use the wire 120A and the wire 120C to select the antenna element 140B. Thus, in the antenna component 100A the control circuitry 130 is able to individually select the antenna element 140A and the antenna element 140B.

The configuration of the selector-switch circuit 110A, selector-switch circuit 110B, wire 120A, wire 120B, and wire 120C shown in FIG. 1A is an example of a switching fabric in which each selector-switch circuit 110 is addressable by a respective unique pair of wires 120. One of the wires 120 of the unique pair of wires 120 is coupled to a first outer terminal of the selector-switch circuit 110, and the other of the wires 120 of the unique pair of wires 120 is coupled to a second outer terminal of the selector-switch circuit 110 (e.g., for the selector-switch circuit 110A, one of the wires 120 is coupled to the outer terminal 116A and the other of the wires 120 is coupled to the outer terminal 116B). The addressing of each selector-switch circuits 110 is controlled by the control circuitry 130 using a unique pair of wires 120 (i.e., in the example of FIG. 1A, the selector-switch circuit 110A is controlled using the wire 120A and the wire 120B, and the selector-switch circuit 110B is controlled using the wire 120A and the wire 120C).

The selector-switch circuits 110, wires 120, antenna elements 140, and control circuitry 130 are coupled together such that the RF path through the antenna elements 140 (the signal(s) being transmitted or received) is substantially isolated from the direct current (DC) signals used by the addressing/selection of antenna elements 140 that is implemented using the switching fabric. Similarly, the DC path used by the switching fabric (a control path) is substantially isolated from the RF signals flowing through the antenna elements 140. A variety of hardware elements can be included to substantially prevent the DC current flowing through the switching fabric from flowing through the plurality of antenna elements 140 and/or to substantially prevent RF signals fed to or flowing through any of the antenna elements 140 from flowing through the switching fabric. These hardware elements can include, for example, at least one of the following: a capacitor, an inductor, a split-ring resonator, a low-pass filter, a high-pass filter, a band-pass filter, a hybrid, a directional coupler, a band-stop filter, a notch filter, a splitter, a transformer, a waveguide filter, a stub, and/or a resistor.

In some embodiments, the wire 120A, the wire 120B, and/or the wire 120C are high-inductance wires, where “high-inductance” means that the wires 120 have sufficient inductance to substantially prevent RF signals flowing through the antenna element 140A and antenna element 140B from flowing through the wire 120A, the wire 120B, and/or the wire 120C. In some embodiments, low-pass filters are situated on or coupled to the wire 120A, the wire 120B, and/or the wire 120C to substantially block RF signals. In some embodiments, inductors are situated on or coupled to the wire 120A, the wire 120B, and/or the wire 120C to substantially block RF signals. In some embodiments, the wires 120 have sufficient resistance to substantially prevent RF signals from flowing along the wires 120. It will be appreciated that other techniques can be used to substantially isolate the selector-switch circuit 110A, selector-switch circuit 110B, and/or control circuitry 130 from RF signals fed to or flowing through the antenna element 140A and antenna element 140B. The examples provided herein are not intended to be limiting.

As illustrated in FIG. 1A, in some embodiments, the selector-switch circuit 110A comprises a selector 112A coupled in series to a memory cell 114A. Similarly, the selector-switch circuit 110B comprises a selector 112B coupled in series to a memory cell 114B. In some embodiments, the selector 112A and selector 112B are two-terminal devices that have a high resistance in an “off” or non-conductive state (in which the selector 112 acts as an open switch), and a low resistance in an “on” or conductive state (in which the selector 112 acts as a closed switch). When in the on/conductive state, the selector 112A and selector 112B allow the memory cell 114A and the memory cell 114B to be accessed/set (e.g., to a high resistance value, to a low resistance value, or to an intermediate resistance value).

The selector 112A and the selector 112B can be any suitable components that provide switching functionality to allow the memory cell 114A and memory cell 114B to be set. In some embodiments, the selector 112A and/or the selector 112B are diodes. In some embodiments, the selector 112A and/or the selector 112B are transistors.

In some embodiments, the selector 112A and/or the selector 112B are threshold switching devices. A threshold switching device is a type of electronic component that exhibits a sudden change in resistance when the applied voltage or current reaches a specific threshold value. A threshold switching device can include an active layer comprising a switching material that undergoes a structural change (e.g., formation of a conductive filament, a change in the local structure of the material, etc.) in response to an applied voltage. The material acts like an insulator (high-resistance state) in response to an applied voltage being in a range below a threshold voltage (or threshold current) and like a conductor (low-resistance state) in response to the applied voltage (or current) exceeding the threshold.

In some embodiments, the selector 112A and the selector 112B are threshold switching devices that use chalcogenide as the switching material. When the switching material is an amorphous chalcogenide, in the high-resistance (off) state, the electronic structure of the material is such that charge carriers are not freely mobile. In this state, the switching material is said to be substantially non-conductive. The switching material stays in the high-resistance state until the applied voltage exceeds specific threshold voltage (Vₜₕ), at which point the material rapidly (typically in nanoseconds) switches to a conductive, low-resistance (on) state. In the conductive state, the electronic structure of the switching material allows for the rapid movement of charge carriers. In this state, the switching material is substantially conductive. When the applied voltage drops below a certain holding voltage (V_{hold}), the switching material rapidly (again, typically in nanoseconds) reverts back to the high-resistance state. When the switching material comprises (or is) a chalcogenide, the threshold switching device can be referred to as an Ovonic threshold switching (OTS) device, an OTS switch, or simply an OTS.

As an alternative to chalcogenides, the switching material of a threshold switching device can be (or comprise) a transition metal oxide (TMO). Transition metal oxides are compounds that have oxygen atoms bonded to transition metals. Transition metals are elements found in the d-block of the periodic table (e.g., titanium, vanadium, chromium, manganese, iron, cobalt, nickel, copper, zinc). The conductivity of TMOs can range from insulating to conducting. TMOs include NbO₂ (niobium dioxide) and V₂O₃:Cr (chromium-doped vanadium sesquioxide). NbO₂ has the ability to undergo rapid (on the other of nanoseconds) metal-to-insulator transitions (MIT) and its threshold switching characteristics. Like a chalcogenide, NbO₂ is characterized by a characteristic threshold voltage (Vₜₕ) at which it switches from a high-resistance state (insulating, at voltages below Vₜₕ) to a low-resistance state (metallic, at voltages above Vₜₕ). The switching is reversible, allowing the device to return to its high-resistance state when the voltage falls below a holding voltage (V_{hold}).

V₂O₃:Cr is vanadium sesquioxide (V₂O₃) doped with chromium (Cr). The switching behavior is provided by the MIT characteristics of V₂O₃ enhanced by chromium doping. The MIT in V₂O₃:Cr can be sensitive to temperature, and the exact transition temperature can be controlled by the amount of Cr doping. The threshold voltage for switching can also be tuned based on the doping level of chromium and the properties of the V₂O₃ material. At or near the transition temperature, V₂O₃:Cr is in a high-resistance (insulating) state, and minimal current flows. When a voltage is applied across the V₂O₃:Cr switch and exceeds a threshold (Vₜₕ), the material undergoes a rapid transition from the insulating state to a metallic state, similarly to NbO₂. In this low-resistance state, V₂O₃:Cr behaves like a metal, with much lower resistance, allowing a large current to flow through. The V₂O₃:Cr switch remains in the low-resistance state as long as the applied voltage or current is maintained above the threshold. When the applied voltage is removed or drops below the holding voltage (V_{hold}), V₂O₃:Cr reverts to its high-resistance (insulating) state, resetting the switch.

Using threshold switching devices (e.g., an OTS device or a TMO device) as the selector 112 of a selector-switch circuit 110 can be advantageous relative to using other hardware. For example, relative to a diode, a threshold switching device has a sharper, more abrupt switching characteristic. In addition, a threshold switching device can be implemented in a small area and inexpensively. Another advantage of using a threshold switch as the selector 112 is that, unlike for approaches such as those that use transistors, additional control lines need not be provided to allow the memory cell 114 to be selected. As long as the voltage applied to a selector 112 exceeds Vₜₕ, the corresponding memory cell 114 is accessible to the control circuitry 130, and its state can be modified by the same voltage/current that causes the selector 112 to switch to the “on” or low-resistance state.

In some embodiments, the threshold voltage Vₜₕ of the selector 112 is lower than the voltage(s) required to change the state of the corresponding memory cell 114. For example, if Vₜₕ for the selector 112 is 0.7 V, and a voltage of 2 V is required to perform a particular state change of the corresponding memory cell 114, applying 2 V across the selector-switch circuit 110 will both turn on the selector 112 and allow the particular state change of the corresponding memory cell 114 to be accomplished. Therefore, the antenna component 100A (and other antenna components 100 described herein) can be implemented more compactly than conventional antennas because fewer control lines are required for addressing/selection. Furthermore, threshold switching devices such as those described above can be implemented compactly (e.g., without a CMOS process). As explained further below, the compact size of threshold switching devices allows many such devices to be provided in a switching fabric, which allows flexibility in terms of the configurations of antenna elements 140 that can be supported.

In the antenna component 100A, the control circuitry 130 is coupled to the selector 112A by the wire 120B and to the selector 112B by the wire 120C. By selectively applying current to the selector 112A (e.g., by applying a potential across the selector-switch circuit 110A using the wire 120A and the wire 120B), the control circuitry 130 can control the state of the selector 112A (e.g., high resistance/non-conductive/off or low resistance/conductive/on). Likewise, by selectively applying current to the selector 112B (e.g., by applying a potential across the selector-switch circuit 110B using the wire 120A and the wire 120C), the control circuitry 130 can control the state of the selector 112B. By controlling the states of the selector 112A and the selector 112B, and the settings of the memory cell 114A and memory cell 114B, the control circuitry 130 can individually select the antenna element 140A and the antenna element 140B, which are connected, respectively, to the memory cell 114A and the memory cell 114B in the illustrated example.

In some embodiments, each of the memory cell 114A and the memory cell 114B has two states, namely, a high-resistance state and a low-resistance state. When the memory cell 114A (or memory cell 114B) is in the high-resistance state, the antenna element 140A is essentially presented as an open circuit (de-selected). When the memory cell 114B (or memory cell 114B) is in the low-resistance state, the antenna element 140A is selected. The memory cell 114B operates similarly with respect to allowing the control circuitry 130 to select and deselect the antenna element 140B.

The memory cell 114A and memory cell 114B can be any suitable devices that are operable to present at least two resistance states, depending on their programming. For example, the memory cell 114A and/or memory cell 114B can be a resistive random access memory (ReRAM), a phase-change memory (PCM), a magnetoresistive random access memory (MRAM), or any other suitable types of memory cell. The memory cell 114A and/or memory cell 114B can include the same kinds of materials as described above for the switching material of the selector 112A and/or selector 112B (e.g., phase-change materials, chalcogenides, etc.). In some embodiments, the memory cell 114A and/or the memory cell 114B is nonvolatile.

FIG. 1B is a diagram of another antenna component 100B in accordance with some embodiments. In addition to the components shown in FIG. 1A and described above, the antenna component 100B includes a reference plane 150, a capacitor 160A, a capacitor 160B, and a capacitor 160C.

Like the selector-switch circuit 110A shown in FIG. 1A, the selector-switch circuit 110A comprises a selector 112A coupled in series to a memory cell 114A. The selector-switch circuit 110A has an outer terminal 116A, an outer terminal 116C, and an inner terminal 118A. Similarly, the selector-switch circuit 110B comprises a selector 112B coupled in series to a memory cell 114B. The selector-switch circuit 110B has an outer terminal 116B, an outer terminal 116D, and an inner terminal 118B. As in the antenna component 100A of FIG. 1A, the outer terminal 116B of the selector-switch circuit 110B is coupled to the outer terminal 116A of the selector-switch circuit 110A by a wire 120A, and the antenna element 140A and the antenna element 140B are also coupled to the wire 120A. The selector 112A, selector 112B, memory cell 114A, memory cell 114B, and control circuitry 130 were described above in the discussion of FIG. 1A. That description also applies to FIG. 1B and is not repeated here.

The antenna component 100B example shown in FIG. 1B also includes a reference plane 150, which may be situated at any convenient location (e.g., the feed point where a transmission line connects to the overall antenna, which could be the antenna component 100B itself or an antenna that incorporates the antenna component 100B). The reference plane 150 can have any suitable physical form (e.g., it can be a layer of a printed circuit board (PCB), etc.). The reference plane 150 can be defined in terms of the physical placement of the antenna (e.g., the ground plane in a monopole antenna or a specific point along a directional antenna array).

As will be appreciated from FIG. 1B, the selector-switch circuit 110A, and specifically the state of the memory cell 114A, determines whether there is a path from the antenna element 140A to the reference plane 150. When the memory cell 114A is in a low-resistance state, it acts as a closed switch, thereby providing the antenna element 140A with a path to the reference plane 150, and when the memory cell 114A is in a high-resistance state, it acts as an open switch, thereby substantially blocking the path between the antenna element 140A and the reference plane 150. Similarly, the state of the memory cell 114B of the selector-switch circuit 110B determines whether there is a path from the antenna element 140B to the reference plane 150 (i.e., when the memory cell 114B is in a low-resistance state, the antenna element 140B has a path to the reference plane 150, and when the memory cell 114B is in a high-resistance state, it substantially blocks the path between the antenna element 140B and the reference plane 150).

The antenna component 100B also includes a capacitor 160A situated on a path between the inner terminal 118A of the selector-switch circuit 110A and the reference plane 150, a capacitor 160B situated on a path between the inner terminal 118B of the selector-switch circuit 110B and the reference plane 150, and a capacitor 160C situated on a path between the wire 120A and the reference plane 150. An implementation may include all of the capacitor 160A, the capacitor 160B, and the capacitor 160C, or it may include fewer than all of them. Similarly, if present, the capacitor 160A, capacitor 160B, and/or capacitor 160C can be situated differently than shown in FIG. 1B, as explained herein. The purpose of the capacitor 160A, the capacitor 160B, and the capacitor 160C in the antenna component 100B is to substantially prevent DC signals (e.g., generated by the control circuitry 130 and flowing on the wire 120A, wire 120B, and/or wire 120C) from flowing through the antenna element 140A and the antenna element 140B. In other words, the capacitor 160A, capacitor 160B, and capacitor 160C suppress DC signals that might otherwise flow through the antenna element 140A and antenna element 140B by interrupting the DC path between the control/selection circuitry and the antenna element 140A and antenna element 140B.

As explained in the discussion of FIG. 1A, the wire 120A, the wire 120B, and/or the wire 120C can be high-inductance wires. Alternatively or in addition, low-pass filters can be situated on or coupled to wire 120A, the wire 120B, and/or the wire 120C, and/or inductors can be situated on or coupled to the wire 120A, the wire 120B, and/or the wire 120C to isolate the selector-switch circuit 110A, selector-switch circuit 110B, and/or control circuitry 130 from RF signals fed to or flowing through the antenna element 140A and antenna element 140B. Thus, in the configuration shown in FIG. 1B, the RF path and the DC path can be isolated from each other, thereby isolating signals flowing through the switching fabric (e.g., the selector-switch circuits 110 and the wires 120) from signals flowing through the antenna elements 140.

FIG. 1C is a diagram of another antenna component 100C in accordance with some embodiments. Many of the elements of FIG. 1C (e.g., the selector 112A, selector 112B, memory cell 114A, memory cell 114B, and control circuitry 130) are as shown and described above in the context of FIG. 1B. That explanation applies as well to FIG. 1C and is not repeated here. In FIG. 1C, the antenna element 140A is coupled to the inner terminal 118A of the selector-switch circuit 110A, the antenna element 140B is coupled to the inner terminal 118B of the selector-switch circuit 110B, and the wire 120A is coupled to the reference plane 150 through a capacitor 160. Coupling the antenna element 140A to the inner terminal 118A and coupling the antenna element 140B to the inner terminal 118B can be advantageous to reduce losses and/or support different circuit topologies.

FIG. 1D is a diagram illustrating an antenna component 100D in accordance with some embodiments. FIG. 1D illustrates how the various hardware elements of the antenna component 100D can be connected or coupled together. In the illustrated example, a selector-switch circuit 110 (comprising a selector 112 and a memory cell 114 as described above in the context of FIG. 1A) is situated as shown. The wire 120A is shown situated below the selector-switch circuit 110 (e.g., connected to either the outer terminal 116A or outer terminal 116B), and the wire 120B is shown situated over the selector-switch circuit 110 (e.g., connected to either the outer terminal 116B or the outer terminal 116A). The wire 120A and wire 120B are coupled to the control circuitry 130 described above (not illustrated in FIG. 1D to avoid obscuring the drawing). An antenna element 140 is coupled to the selector-switch circuit 110 as shown (e.g., to an inner terminal 118, or to the outer terminal 116A or outer terminal 116B). The wire 120A is coupled to a reference plane 150 through a capacitor 160. Depending on the state of the memory cell 114 of the selector-switch circuit 110, there either is or is not an RF path between the antenna element 140 and the reference plane 150 (i.e., when the memory cell 114 is in the low resistance state, there is a an RF path from the antenna element 140 to the reference plane 150, and when the memory cell 114 is in the high-resistance state, the RF path from the antenna element 140 to the reference plane 150 is substantially blocked by the memory cell 114).

FIG. 1E is a diagram illustrating an antenna component 100E in accordance with some embodiments. FIG. 1E is similar to FIG. 1D, except that it shows two selector-switch circuits 110 and two antenna elements 140. Specifically, the antenna component 100E includes a selector-switch circuit 110A coupled to an antenna element 140A and a selector-switch circuit 110B coupled to an antenna element 140B. The selector-switch circuit 110A is shown situated between and coupled to the wire 120A and the wire 120B, and the selector-switch circuit 110B is shown situated between and coupled to the wire 120A and the wire 120C. A capacitor 160 is situated between the wire 120A and the reference plane 150 to isolate the DC and RF paths as described above.

The wire 120A, wire 120B, and wire 120C are coupled to control circuitry 130 (not illustrated in FIG. 1E to avoid obscuring the drawing), which can then select and set/alter the memory cell 114A of the selector-switch circuit 110A using the wire 120A and the wire 120B. Likewise, the control circuitry 130 can select and set/alter the memory cell 114B of the selector-switch circuit 110B using the wire 120A and the wire 120C. By setting the resistances of the memory cell 114A and memory cell 114B, the control circuitry 130 can control whether there is an RF path from the antenna element 140A to the reference plane 150 and whether there is an RF path from the antenna element 140B to the reference plane 150.

Although FIG. 1E illustrates only two antenna elements 140 and the associated selector-switch circuits 110 and wires 120, it is to be appreciated that an implementation can include many more antenna elements 140, selector-switch circuits 110, and wires 120. It should also be appreciated that although FIG. 1E illustrates a capacitor 160 situated between the wire 120A and the reference plane 150, there are other ways that the DC signals on the wires 120 can be substantially prevented from flowing through the antenna elements 140, as described above. Conversely, FIG. 1E suggests that the wires 120 have high enough inductance to substantially suppress RF signals fed to or flowing through the antenna elements 140 that might otherwise flow through the wires 120, but it is to be appreciated that other techniques (e.g., lowpass filters, inductors, etc.) can be used instead or in addition, as explained above.

The antenna components 100 shown in FIGS. 1A-1E and described above implement addressing/selection of antenna elements 140 using switching fabrics in which each selector-switch circuit 110 is controlled by the control circuitry 130 using a unique pair of wires 120. For example, with reference to FIG. 1E, the selector-switch circuit 110A is controlled using the wire 120A and wire 120B, and the selector-switch circuit 110B is controlled using the wire 120A and the wire 120C. Conversely, in the illustrated example, each unique pair of wires 120 selects only one of the selector-switch circuits 110 and its respective antenna element 140.

As will be appreciated by those having ordinary skill in the art in light of the teachings herein, the structural components of an antenna component 100 can be arranged in a variety of ways to allow the elements of the antenna component that select and configure the antenna elements 140 (the switching fabric and control circuitry 130) to be coupled to the antenna elements 140 in a way that substantially isolates the RF path through the antenna elements 140 from the DC path used by the select/configure circuitry (and vice versa). The examples presented herein are not intended to be limiting.

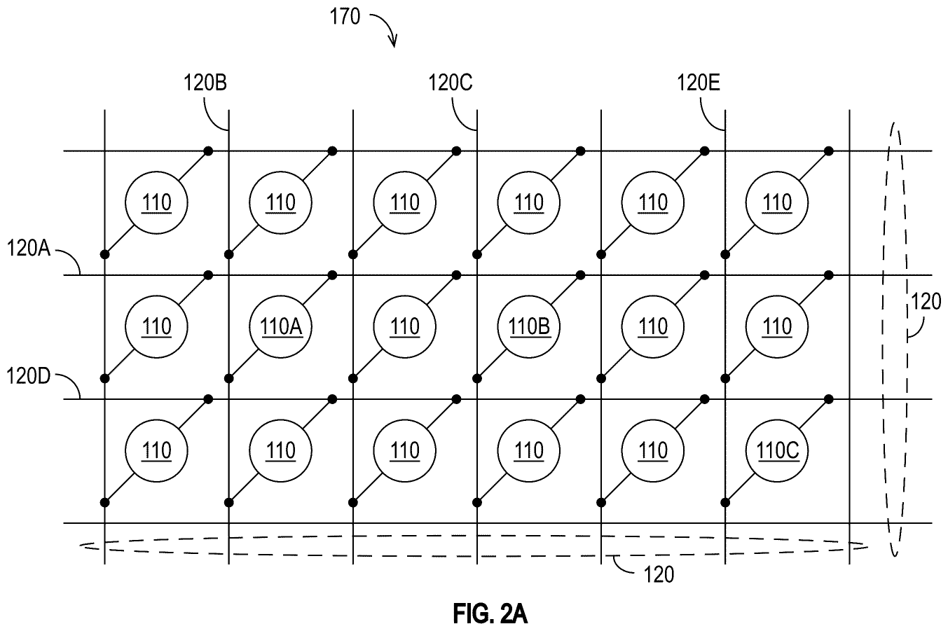

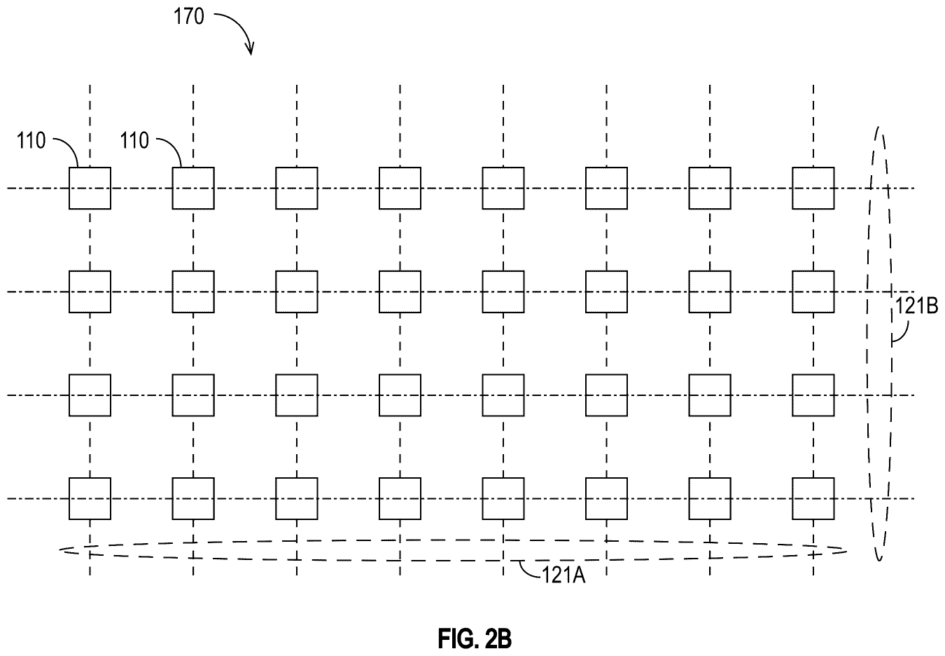

FIG. 2A is a diagram illustrating an example of a larger switching fabric 170 in accordance with some embodiments. The switching fabric 170 example shown in FIG. 2A is a cross-point architecture structure, but it is to be appreciated that, as stated above, the switching fabric 170 can have other architectures. The switching fabric 170 of FIG. 2A includes a plurality of wires 120 and a plurality of selector-switch circuits 110. Five of the individual wires 120 are labeled in FIG. 2A, namely the wire 120A, the wire 120B, the wire 120C, the wire 120D, and the wire 120E. For convenience of illustration, FIG. 2A shows a row/column structure with some of the wires 120, including the wire 120A and wire 120D, selecting rows and the rest of the wires 120, including the wire 120B, wire 120C, and wire 120E, selecting columns, but there is no requirement for a switching fabric 170 to have a row/column structure. Because the antenna elements 140 are not required to be in a planar arrangement (e.g., they could be on a curved or other non-flat surface, or generally situated in a non-planar three-dimensional configuration), the wires 120 of the switching fabric 170 can have any convenient orientation or layout in an implementation.

The plurality of wires 120 is coupled to control circuitry 130 (e.g., as illustrated in FIGS. 1A-1C). As in other drawings, the control circuitry 130 is not illustrated in FIG. 2A to avoid obscuring the drawing.

The selector-switch circuits 110 can be as described above and illustrated in any or all of FIGS. 1A, 1B, 1C, 1D, and 1E. Specifically, each of the selector-switch circuits 110 can include a selector 112 and a memory cell 114 coupled in series (e.g., as shown and described above in the context of FIGS. 1A and 1B).

A key characteristic of the switching fabric 170 is that each selector-switch circuit 110 is addressable (e.g., selectable by the control circuitry 130) using a unique pair of wires 120. In some embodiments, each unique pair of wires selects no more than one selector-switch circuit 110. It is to be appreciated that it is not a requirement for each unique pair of wires to select no more than one selector-switch circuit 110.

For example, the wire 120A and wire 120B select the selector-switch circuit 110A, the wire 120A and wire 120C select the selector-switch circuit 110B, and the wire 120D and wire 120E select the selector-switch circuit 110C. Likewise, the selector-switch circuit 110A is selectable only by the wire 120A and the wire 120B, the selector-switch circuit 110B is selectable only by the wire 120A and wire 120C, and the selector-switch circuit 110C is selectable only by the wire 120D and wire 120E. It can be verified by inspection of FIG. 2A that each of the selector-switch circuits 110 is addressable by a unique combination of wires 120, and, conversely, each unique combination of a “row” wire 120 and a “column” wire 120 selects only one selector-switch circuit 110.

In combination with the antenna elements 140 and RF and DC isolation techniques described above in the context of FIGS. 1A, 1B, 1C, 1D, and/or 1E (e.g., techniques using hardware elements (e.g., capacitors, inductors, low-pass filters, split-ring resonators, etc.) to isolate the RF path among the antenna elements 140 from the DC path used by the control circuitry 130 to select/deselect/control the selector-switch circuits 110, and vice versa), the switching fabric 170 of FIG. 2A can be included in an antenna component 100 to provide a flexible, integrated implementation.

FIG. 2B is another illustration of an example of a switching fabric 170 in accordance with some embodiments. The switching fabric 170 example shown in FIG. 2B is another cross-point architecture structure, but it is to be appreciated that, as stated above, the switching fabric 170 can have other architectures. FIG. 2B can be considered a top view of the switching fabric 170, with the selector-switch circuits 110 situated as shown in FIGS. 1D and 1E, with one of the wires 120 situated above the selector-switch circuit 110, and the other of the wires 120 situated below it. In FIG. 2B, a first plurality of wires 121A, shown as column wires 120, is situated under the selector-switch circuits 110, and a second plurality of wires 121B, shown as row wires 120, is situated over the selector-switch circuits 110. The first plurality of wires 121A and second plurality of wires 121B are coupled to control circuitry 130, which is not illustrated in FIG. 2B. To avoid obscuring the drawing, only two of the selector-switch circuits 110 are labeled in FIG. 2B.

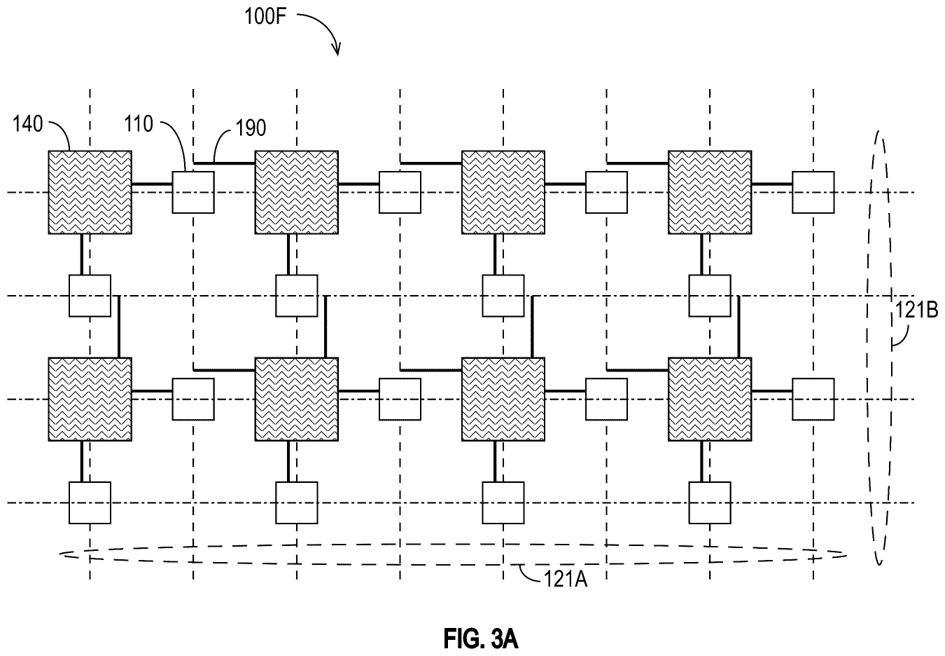

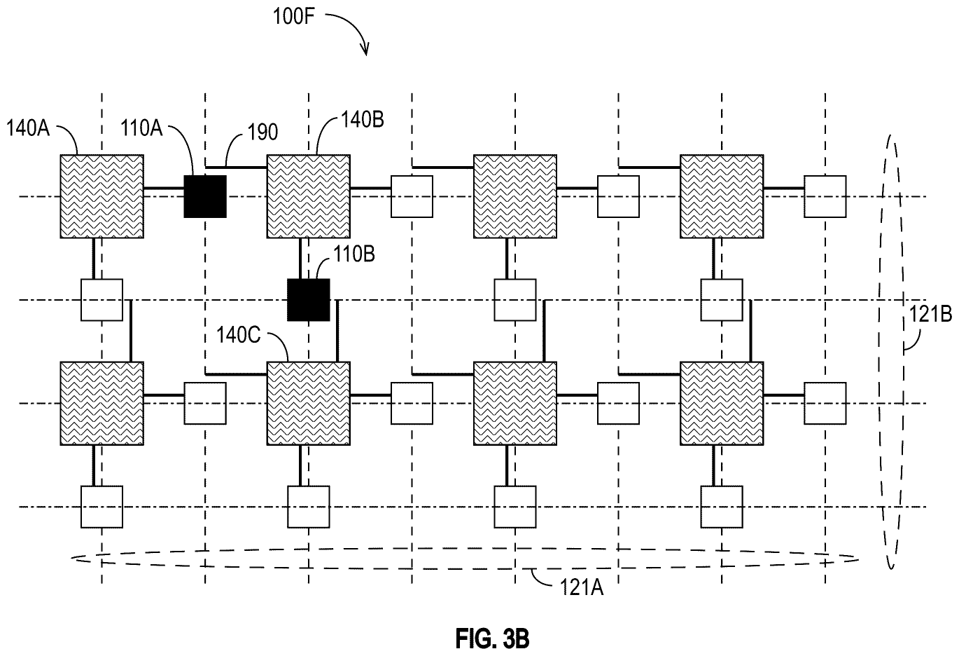

The switching fabric 170 of FIG. 2B can be augmented by other hardware elements (e.g., antenna elements 140) to form an antenna component 100. FIG. 3A is an illustration of an antenna component 100F that uses a switching fabric 170 such as the example shown in FIG. 2B in accordance with some embodiments. The antenna component 100F includes the switching fabric 170 of FIG. 2B overlaid by and coupled to a plurality of antenna elements 140. To avoid obscuring the drawing, only one antenna element 140 and only one selector-switch circuit 110 are labeled with reference numerals. FIG. 3A also includes a plurality of connections 190, shown in thicker lines. The plurality of connections 190 can be used in combination with the selector-switch circuits 110 to connect antenna elements 140 to each other (e.g., create an RF path between antenna elements 140) in a variety of patterns. Although not illustrated, each of the plurality of connections 190 can include hardware to substantially prevent DC signals on the first plurality of wires 121A and/or second plurality of wires 121B from flowing through the antenna elements 140. For example, each plurality of connections 190 can include a capacitor to substantially block DC signals.

FIG. 3B is an example to illustrate how the selector-switch circuits 110 of FIG. 3A can be configured to connect antenna elements 140 to each other. In the example of FIG. 3B, the selector-switch circuit 110A is situated between an antenna element 140A and an antenna element 140B, and a selector-switch circuit 110B is situated between the antenna element 140B and an antenna element 140C. The control circuitry 130 (not illustrated in FIG. 3B) can use the wire 120A and the wire 120C to select the selector-switch circuit 110A and set the state of the associated corresponding memory cell 114 to the low-resistance state (closed switch, indicated by shading the selector-switch circuit 110A black). Likewise, the control circuitry 130 can use the wire 120B and the wire 120D to set the state of the associated corresponding memory cell 114 to the low-resistance (closed) state. By doing so, the antenna element 140A, antenna element 140B, and antenna element 140C can be coupled together. In other words, the antenna element 140A, antenna element 140B, and antenna element 140C can be configured so that they appear to be combined.

In some embodiments, the 140A// and antenna element 140B in FIG. 3B form parts of a split-ring resonator, such as two concentric arc segments. By configuring the selector-switch circuit 110A situated between the antenna element 140A and the antenna element 140B into a low-resistance state, the arc segments are coupled together.

In some embodiments, the antenna element 140A and the antenna element 140B in FIG. 3B correspond to two nodes in a resonant circuit, such as, for example, the two ends of an arc segment of a split-ring resonator. By configuring the selector-switch circuit 110A situated between the two nodes, the properties of the resonant circuit are changed. For example, by connecting the ends of the arc segment, the arc is closed, and the resonator is detuned compared to a gapped split-ring resonator.

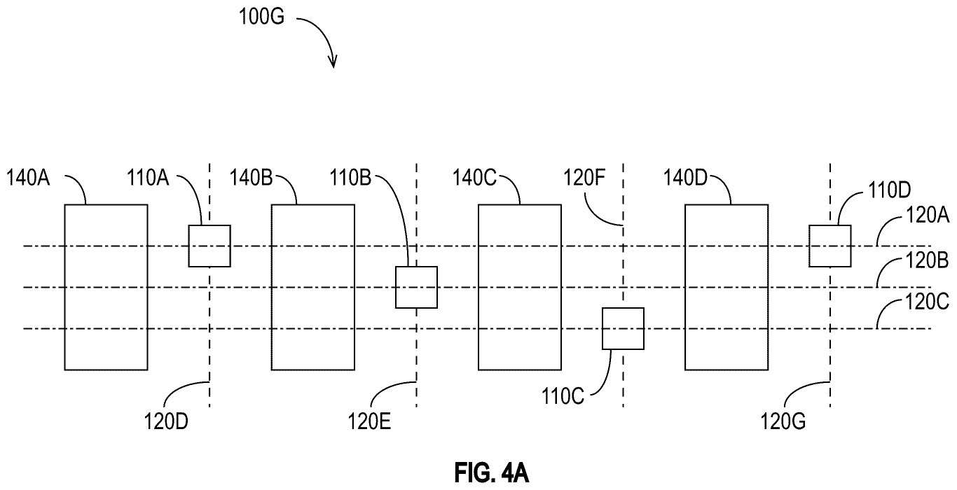

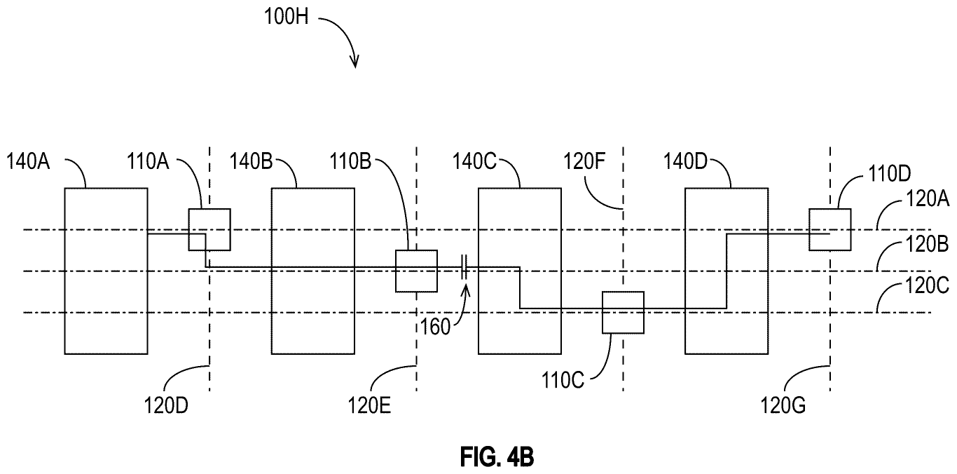

FIG. 4A shows an antenna component 100G that uses additional wires 120 to allow flexibility in configuring the antenna elements 140. Instead of one “row” wire 120, the antenna component 100G has three “row” wires 120, namely the wire 120A, wire 120B, and wire 120C. The control circuitry 130 (not illustrated to avoid obscuring the drawing) can use the wire 120A and wire 120D to set the memory cell 114A of the selector-switch circuit 110A to the low-resistance state to couple the antenna element 140A and antenna element 140B together. Similarly, the control circuitry 130 can use the wire 120B and wire 120E to set the memory cell 114B of the selector-switch circuit 110B to the low-resistance state to couple in the antenna element 140C, and the wire 120C and the wire 120F to set the memory cell 114 of the selector-switch circuit 110C to the low-resistance state to couple in the antenna element 140D. But using the wire 120A and the wire 120G to set the memory cell 114 of the selector-switch circuit 110D to the low-resistance state causes a loop/short-circuit.

FIG. 4B illustrates one example solution to the problem of FIG. 4A in accordance with some embodiments. As shown in FIG. 4B, the antenna component 100H includes a capacitor 160 is situated between the selector-switch circuit 110B and the selector-switch circuit 110C. The capacitor 160 interrupts the DC path and allows the antenna element 140A and antenna element 140B to be selected and coupled together, and the antenna element 140C and antenna element 140D to be selected and coupled together independently of the antenna element 140A and antenna element 140B. This approach can be expanded to include various combinations of the selector-switch circuits 110 and antenna elements 140.

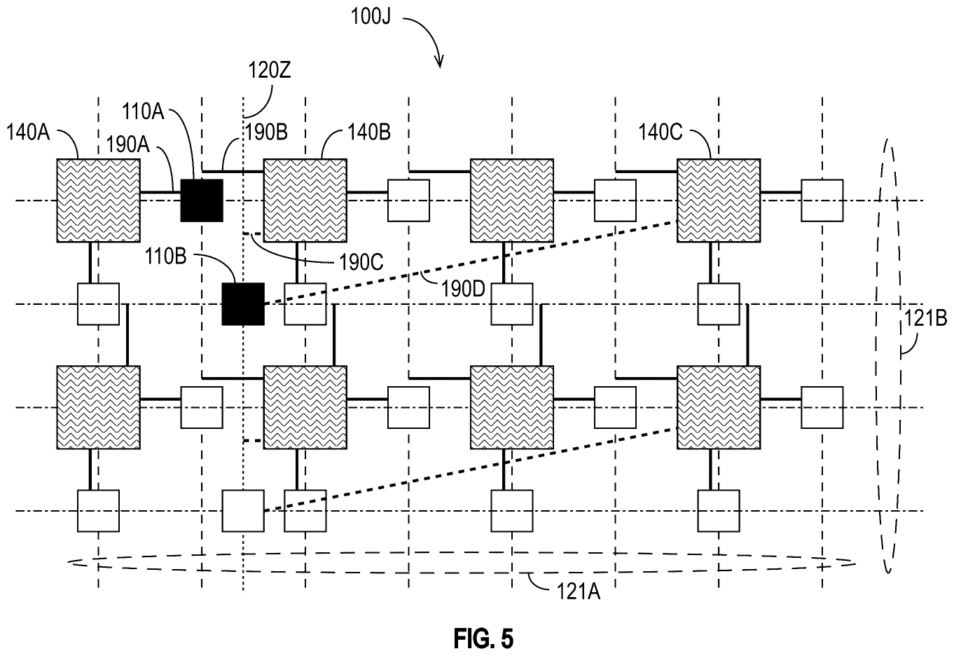

The use of a plurality of connections 190 as described above in the discussion of FIG. 3B can be expanded to allow additional subsets of antenna elements 140 to be coupled together. FIG. 5 is an illustration of an example of an antenna component 100J that allows additional combinations of antenna elements 140 to be coupled together in accordance with some embodiments. As shown, additional selector-switch circuits 110 and additional wires 120 can be included in the antenna component 100J to provide additional flexibility. For example, in addition to the wires 120 shown in FIG. 3B, FIG. 5 shows the addition of a wire 120Z, which is coupled to additional selector-switch circuits 110, including the selector-switch circuit 110B. In the illustrated example, the antenna element 140A is coupled to the antenna element 140B through the connection 190A, the selector-switch circuit 110A, and the connection 190B. The antenna element 140B is coupled to the antenna element 140C through the connection 190C, the selector-switch circuit 110B, and the connection 190D. The illustrated configuration can be accomplished by setting the memory cells 114 in the selector-switch circuit 110A and the selector-switch circuit 110B to the low-resistance state (indicated as the selector-switch circuits 110 being shaded black).

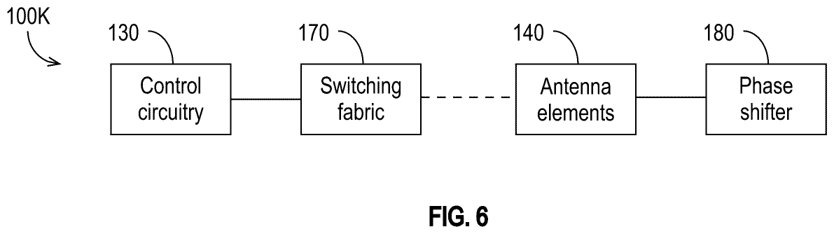

FIG. 6 is a diagram illustrating components of another antenna component 100K in accordance with some embodiments. The antenna component 100K includes control circuitry 130 coupled to a switching fabric 170 (e.g., as shown in the figures and described above), which is coupled to antenna elements 140. The switching fabric 170 can be directly connected to the antenna elements 140, or it can be connected through intervening components (e.g., capacitors or other elements that can isolate the RF path through the antenna elements 140 from the DC path(s) through the switching fabric 170). In the example of FIG. 6, the antenna elements 140 are coupled to a phase shifter 180. As will be appreciated, a phase shifter 180 is a device or component used (e.g., in phased array antennas) to control the phase of the RF signal feeding some or all of the antenna elements 140. The phase shifter 180 can introduce a controlled delay in the RF signal, which effectively changes the phase angle of the signal, which alters the constructive and destructive interference patterns in the radiated wavefront. The phase shifter 180 can apply different phase shifts to the antenna elements 140 (collectively or individually) and electronically steer the direction and shape of the main radiation beam. Thus, by adjusting the phase(s) of the RF signal, the phase shifter 180 allows the antenna to steer its beam in different directions without physically moving the antenna.

If included, the phase shifter 180 can be an analog phase shifter (e.g., a varactor diode phase shifter, a ferrite phase shifter, etc.), a digital phase shifter (e.g., comprising switches, delay lines, and/or digital circuits (e.g., digital signal processors)), a mechanical phase shifter (e.g., to physically change the length of the transmission path), or a liquid crystal or MEMS phase shifter.

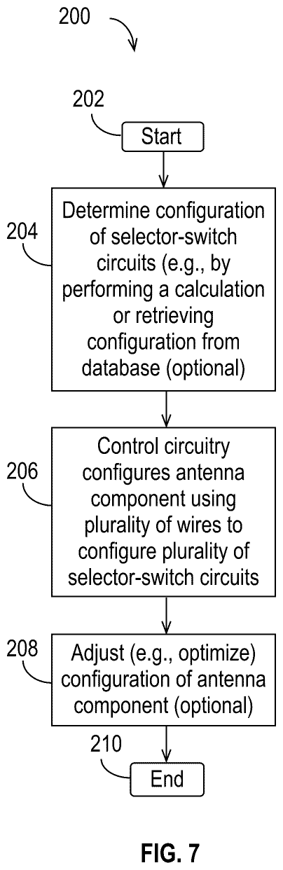

As explained above, the switching fabric 170 described herein allows the control circuitry 130 to configure the antenna component 100 and/or adjust the configuration of the antenna component 100. FIG. 7 is a flow diagram of an example of a method 200 of using an antenna component 100 in accordance with some embodiments. At block 202, the method 200 begins. At block 204, a configuration of the selector-switch circuits 110 is determined. For example, the configuration may be a pre-set configuration for a particular geography/location, time of day, expected or actual signal strength, jamming condition, interference condition, or weather condition. The configuration can be determined in any suitable manner. In some embodiments, the configuration is determined by performing a calculation. In some embodiments, the configuration is determined by retrieving the configuration from memory (e.g., a database).

At block 206, the control circuitry 130 configures the antenna component using the wires 120 to configure the selector-switch circuits 110 in accordance with the configuration determined at block 204. As explained above, the control circuitry 130 can address individual selector-switch circuits 110 using unique pairs of wires 120 (e.g., in the case that the selector 112 comprises a threshold switching device, by applying a voltage greater than Vₜₕ to cause the selector 112 of the selector-switch circuit 110 to be in the conductive/on state, thereby enabling the corresponding memory cell 114 to be set/modified). As explained above, by controlling/setting the selector-switch circuits 110, the control circuitry 130 can configure the antenna elements 140 of the antenna component 100.

At block 208, optionally, the configuration of the antenna component 100 is adjusted. For example, it may be determined after some elapsed period that the initial configuration of the antenna component 100 is suboptimal, or performance could or should be improved. Thus, at block 208, the configuration can be adjusted (e.g., optimized), if desired. The adjustment of the antenna component 100 can be based on any appropriate factor. For example, the adjustment can be based at least in part on a signal strength (e.g., of a received signal), the radiated power of the antenna, interference suppression, jamming suppression, environmental conditions (e.g., temperature, humidity, presence of rain or fog), etc. The configuration can be adjusted to modify or set the antenna's gain, directivity, bandwidth, frequency (or frequency range), size (actual or apparent), radiation pattern (e.g., beamwidth, sidelobe levels, steering, etc.), polarization (e.g., linear, circular, elliptical, cross-polarization, etc.), or efficiency.

At block 210, the method 200 ends.

For simplicity, this document sometimes illustrates planar arrangements (e.g., FIG. 2A) in which elements (e.g., selector-switch circuits 110) are situated in a grid pattern having rows and columns. It is to be appreciated, however, that the teachings are not limited to grid or planar arrangements and can be applicable to other configurations, such as, for example, linear arrangements, circular or triangular grids, or three-dimensional arrangements. It is not a requirement for a switching fabric 170 to be planar or in a grid arrangement.

Similarly, it is to be appreciated the disclosures are applicable to a variety of antenna elements 140 and types of antennas (e.g., dipole antennas, microstrip antennas, etc.). It will be understood that the selected antenna elements 140 may depend on a variety of factors, such as frequency range.

Although it may be convenient in an implementation to space the antenna elements 140 by about half the wavelength (2/2) of the operating frequency, the disclosed techniques are not limited to 2/2 between antenna elements 140.

As explained above, the teachings herein can be used with techniques such as phase shifting (e.g., applying different phase shifts to signals feeding different antenna elements 140 in the array to steer the direction of the main beam). In addition, or alternatively, the techniques described herein can be used with amplitude weighting (e.g., adjusting the amplitudes of the signals at different antenna elements 140 to control the shape of the radiation pattern, control side lobes, adjust the main lobe's strength, etc.), digital beamforming (e.g., using digital signal processing techniques to control the beam pattern substantially in real-time), and other techniques.

The antenna components 100 described and claimed herein can be used in a variety of antenna types. For example, they can be used in a dipole antenna, a monopole antenna, a loop antenna, a Yagi-Uda antenna, a patch antenna, a parabolic antenna, or a phased array antenna.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.” The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” as used herein refer to a relative position of one feature with respect to other features. For example, one feature disposed “over” or “under” another feature may be directly in contact with the other feature or may have intervening material, components, or features. Moreover, one feature disposed “between” two features may be directly in contact with the two features or may have one or more intervening features, components, or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof.

Accordingly, the specification and drawings are to be regarded in an illustrative rather than a restrictive sense.

1. An antenna component, comprising:
a first circuit comprising a first selector coupled in series to a first memory cell;
a second circuit comprising a second selector coupled in series to a second memory cell;
a first antenna element coupled to the first circuit;
a second antenna element coupled to the second circuit; and
control circuitry coupled to the first circuit and the second circuit, wherein the control circuitry is configured to use the first circuit to select the first antenna element and use the second circuit to select the second antenna element.

2. The antenna component recited in claim 1, wherein at least one of the first memory cell or the second memory cell is nonvolatile.

3. The antenna component recited in claim 1, further comprising:
a first wire coupled to a first terminal of the first circuit, to a first terminal of the second circuit, and to the control circuitry;
a second wire coupled to a second terminal of the first circuit and to the control circuitry; and
a third wire coupled to a second terminal of the second circuit and to the control circuitry,
and wherein the control circuitry is configured to access the first circuit using the first wire and the second wire, and to access the second circuit using the first wire and the third wire.

4. The antenna component recited in claim 3, further comprising:
a reference plane; and
a capacitor coupling at least one of the first wire, the second wire, the third wire, the first circuit, or the second circuit to the reference plane.

5. The antenna component recited in claim 1, further comprising:
a reference plane; and
a capacitor coupling at least one the first circuit or the second circuit to the reference plane.

6. The antenna component recited in claim 1, wherein the first antenna element is connected to the first memory cell of the first circuit and the second antenna element is connected to the second memory cell of the second circuit.

7. An antenna component, comprising:
a switching fabric comprising:
a plurality of wires, and
a plurality of selector-switch circuits, each of the plurality of selector-switch circuits being addressable by a respective unique pair of wires of the plurality of wires; and
a plurality of antenna elements, wherein each antenna element of the plurality of antenna elements is coupled to the switching fabric to substantially prevent direct current on any of the plurality of wires from flowing through the plurality of antenna elements and to substantially prevent radio-frequency signals fed to or flowing through any of the plurality of antenna elements from flowing through the plurality of wires.

8. The antenna component recited in claim 7, wherein each selector-switch circuit of the plurality of selector-switch circuits comprises a respective selector coupled in series to a respective memory cell.

9. The antenna component recited in claim 8, wherein the respective memory cell is nonvolatile.

10. The antenna component recited in claim 7, wherein each selector-switch circuit of the plurality of selector-switch circuits comprises:
a respective first outer terminal coupled to a first wire of the respective unique pair of two wires; and
a respective second outer terminal coupled to a second wire of the respective unique pair of two wires.

11. The antenna component recited in claim 10, wherein each selector-switch circuit of the plurality of selector-switch circuits further comprises:
a respective inner terminal coupled to a respective antenna element of the plurality of antenna elements.

12. The antenna component recited in claim 11, wherein each selector-switch circuit of the plurality of selector-switch circuits comprises a respective memory cell, and wherein the respective inner terminal couples the respective antenna element to the respective memory cell.

13. The antenna component recited in claim 7, further comprising a phase shifter coupled to the plurality of antenna elements.

14. The antenna component recited in claim 7, wherein the plurality of antenna elements is arranged in a non-planar configuration.

15. The antenna component recited in claim 7, further comprising one or more hardware elements coupled to the switching fabric and/or the plurality of antenna elements, wherein the one or more hardware elements are configured to substantially prevent the direct current on any of the plurality of wires from flowing through the plurality of antenna elements and/or to substantially prevent the radio-frequency signals fed to or flowing through any of the plurality of antenna elements from flowing through the plurality of wires.

16. The antenna component recited in claim 15, wherein the one or more hardware elements comprise at least one of: a capacitor, an inductor, a split-ring resonator, a low-pass filter, a high-pass filter, a band-pass filter, a hybrid, a directional coupler, a band-stop filter, a notch filter, a splitter, a transformer, a waveguide filter, a stub, or a resistor.

17. The antenna component recited in claim 7, further comprising:
control circuitry coupled to the switching fabric and configured to use the plurality of wires to configure the plurality of selector-switch circuits to configure the plurality of antenna elements.

18. A method of using the antenna component recited in claim 17, comprising:
the control circuitry configuring the antenna component using the plurality of wires to configure the plurality of selector-switch circuits.

19. The method of claim 18, further comprising:
before the control circuitry configuring the antenna component using the plurality of wires to configure the plurality of selector-switch circuits, performing a calculation to determine a configuration of the plurality of selector-switch circuits.

20. The method of claim 18, further comprising:
before the control circuitry configuring the antenna component using the plurality of wires to configure the plurality of selector-switch circuits, retrieving a configuration of the plurality of selector-switch circuits from a database.

21. The method of claim 18, further comprising:
adjusting a configuration of the antenna component.

22. The method of claim 21, wherein adjusting the configuration of the antenna component is based at least in part on a signal strength, a radiated power, a suppression of interference, or a suppression of jamming.

23. An antenna component, comprising:
a switching fabric comprising:
a plurality of wires, and
a plurality of selector-switch circuits, each of the plurality of selector-switch circuits being addressable by a respective unique pair of two wires of the plurality of wires; and
a plurality of antenna elements coupled to the switching fabric; and
at least one hardware element coupled to the plurality of selector-switch circuits and configured to (a) suppress a direct current path through the plurality of antenna elements, (b) substantially prevent radio-frequency signals fed to or flowing through any of the plurality of antenna elements from flowing through the plurality of wires, or (c) both (a) and (b).

24. The antenna component recited in claim 23, wherein the at least one hardware element comprises at least one of: a capacitor, a split-ring resonator, an inductor, a low-pass filter, a high-pass filter, a band-pass filter, a hybrid, a directional coupler, a band-stop filter, a notch filter, a splitter, a transformer, a waveguide filter, a stub, or a resistor.

25. The antenna component recited in claim 23, wherein the plurality of wires and the plurality of selector-switch circuits are situated in a cross-point architecture structure.
